(19) United States
(12) Patent Application Publication
(10) Pub. No.: US 2012/0198888 A1
(43) Pub. Date: Aug. 9, 2012

(54) METHOD FOR PRODUCING REINFORCED ANTIREFLECTION GLASS

(75) Inventors: Hiroaki Hasegawa, Fukui (JP); Hirokazu Hashimoto, Fukui (JP)

(73) Assignee: FUKUVI CHEMICAL INDUSTRY CO., LTD., Fukui (JP)

(21) Appl. No.: 13/501,312

(22) PCT Filed: Oct. 18, 2010
(86) PCT No.: PCT/JP2010/068245

§ 371 Date: Apr. 11, 2012

(30) Foreign Application Priority Data
Oct. 20, 2009 (JP) 2009-241741

(51) Int. Cl. C03C 17/30

(52) U.S. Cl. 65/17.2

(57) ABSTRACT

To provide a method of producing a reinforced antireflection glass, which reinforces the glass by a chemically reinforcing treatment based on the ion-exchange method after the antireflection film has been formed.

[Means for Solution] A method of producing a reinforced antireflection glass by forming an antireflection film on the surface of a glass substrate and, thereafter, subjecting the glass substrate on which the antireflection film has been formed to a chemically reinforcing treatment based on the ion-exchange method, wherein the antireflection film contains:

(a) a hydrolyzed condensate of a silicon compound represented by the following formula (1),

Rₙ—Si(OR¹)₄₋ₙ (1)

Wherein,
R is an alkyl group or an alkenyl group,
R¹ is an alkyl group or an alkoxyalkyl group, and
n is an integer of 0 to 2,

(b) a silica sol of a grain size of 5 to 150 nm and having a cavity therein, and

(c) a metal chelate compound, the weight ratio (a/b) of the hydrolyzed condensate of the silicon compound (a) and the silica sol (b) being in a range of 50/50 to 90/10, and the metal chelate compound (c) being contained in an amount of not more than 20 parts by weight per a total of 100 parts by weight of the hydrolyzed condensate of the silicon compound (a) and the silica sol (b).

### TECHNICAL FIELD

This invention relates to a method of producing a reinforced antireflection glass.

### BACKGROUND ART

A reinforced glass having an increased strength has been widely used for the applications of window glasses of automobiles and houses and, in recent years, has, further, been used for the applications of whole-surface protection panels of electrostatic capacity-type touch panels, digital cameras and displays of a variety of mobile devices such as cell phones. After the reinforcing treatment has been conducted, however, the reinforced glass cannot be subjected to the shaping such as cutting, machining of end surfaces or perforation. Therefore, the reinforcing treatment is conducted after the glass substrate is worked into the shape of a final product.

As the methods of reinforcing the glasses, there have been known a method of physical reinforcement based on the quenching and a method of chemical treatment based on the exchange of ions.

The method of physical reinforcement, however, is not effective for the glass substrates having small thicknesses. Therefore, the method of chemical treatment has generally been employed for the thin glasses such as of protection panels and displays.

The method of chemical treatment based on the exchange of ions is carried out by substituting metal ions having a large ionic radius (e.g., K ions) for metal ions having a small ionic radius (e.g., Na ions) contained in the glass. Namely, upon substituting the metal ions having a large ionic radius for the metal ions having a small ionic radius, the interior of the glass assumes a state where narrow gaps are propped up. As a result, a layer of compressive stress forms in the surface of the glass. To break the glass, therefore, a force is required for removing the compressive stress in the surface in addition to the force for breaking the bond among the molecules; i.e., the strength very increases as compared to ordinary glasses.

The antireflection function is often required for the reinforced glass, too, that is reinforced by the chemical treatment by exchanging ions. Specifically, the above-mentioned protection panels and various displays require the function of antireflection.

To impart the antireflection function, an antireflection film of a low refractive index may be formed on the surface. Known means for forming the antireflection film can roughly be divided into a method based on the vacuum evaporation and a sol-gel method. The method based on the vacuum evaporation, however, needs a very expensive apparatus and has not, therefore, been so much put into practice on an industrial scale. At present, therefore, the sol-gel method has been mainly employed on account of its low production cost and high productivity, i.e., by applying a coating solution containing fine particles followed by the heat treatment to turn the solution into a gel thereof to thereby form an antireflection film.

A known antireflection film formed by the sol-gel method contains, for example, a hydrolyzed condensate of a silicon compound, a metal chelate compound and a lowly refractive silica sol (see patent document 1).

### PRIOR ART DOCUMENTS

Patent Documents:

Patent document 1: JP-A-2002-221602

### OUTLINE OF THE INVENTION

### Problems that the Invention is to Solve

A serious problem, however, must be solved in order to form an antireflection film on the surface of a reinforced glass obtained by the chemical treatment.

As described above, the reinforced glass is shaped before being put to the reinforcing treatment. With the reinforced glass obtained by the chemical treatment, however, the antireflection film must be formed after the reinforcing treatment has been conducted. This is because after the antireflection film is formed, K ions can no longer be permeated into the glass and, therefore, the reinforcing treatment cannot be executed. Here, however, the shaping has been conducted prior to the reinforcing treatment (chemical treatment based on the exchange of ions) and, therefore, the antireflection film must be formed after the glass has been shaped. Namely, though the antireflection film can be formed by the sol-gel method which features a high productivity, the antireflection film must be formed for each product that has been shaped causing a great decrease in the production efficiency and completely cancelling the advantage of the sol-gel method.

In fact, the antireflection film proposed by the patent document 1 is applied to the surfaces of a plastic light-transmitting substrate but has not been applied to the reinforced glass and, specifically, to the reinforced glass obtained by the chemical treatment based on the ion-exchange method.

It is, therefore, an object of the present invention to provide a method of producing a reinforced antireflection glass, which reinforces the glass by a chemically reinforcing treatment based on the ion-exchange method after the antireflection film has been formed.

Another object of the present invention is to provide a method of producing a reinforced antireflection glass, which is capable of forming an antireflection film prior to the shaping in compliance with forming the antireflection film prior to conducting the chemically reinforcing treatment based the ion-exchange method.

### MEANS FOR SOLVING THE PROBLEM

According to the invention, there is provided a method of producing a reinforced antireflection glass by forming an antireflection film on the surface of a glass substrate and, thereafter, subjecting the glass substrate on which the antireflection film has been formed to a chemically reinforcing treatment based on the ion-exchange method, wherein the antireflection film contains:

(a) a hydrolyzed condensate of a silicon compound represented by the following formula (1),

Rₙ—Si(OR¹)₄₋ₙ (1)

Wherein,
R is an alkyl group or an alkenyl group,
R¹ is an alkyl group or an alkoxyalkyl group, and
n is an integer of 0 to 2,

(b) a silica sol of a grain size of 5 to 150 nm and having a cavity therein, and

(c) a metal chelate compound, the weight ratio (a/b) of the hydrolyzed condensate of the silicon compound (a) and the silica sol (b) being in a range of 50/50 to 90/10, and the metal chelate compound (c) being contained in an amount of not more than 20 parts by weight per a total of 100 parts by weight of the hydrolyzed condensate of the silicon compound (a) and the silica sol (b).

In the method of production of the present invention, it is desired that:

(1) The antireflection film contains the metal chelate compound (c) in an amount of 0.01 to 20 parts by weight per a total of 100 parts by weight of the hydrolyzed condensate of the silicon compound (a) and the silica sol (b);
(2) The antireflection film has a thickness in a range of 50 to 150 nm;
(3) The silicon compound is a compound of the formula (1) in which n is 0 or 1 and is, specifically, a tetraethoxysilane or a γ-glycidoxypropyltrimethoxysilane; and
(4) After the antireflection film has been formed, the glass substrate is shaped prior to being subjected to the chemically reinforcing treatment.

### EFFECTS OF THE INVENTION

In the invention, a distinguished feature resides in that the antireflection film that is formed before the glass substrate is chemically reinforced by the ion-exchange method, contains (b) a fine silica sol having a cavity therein at a predetermined ratio (hereinafter often called hollow silica sol) together with (a) a hydrolyzed condensate of a silicon compound which is a binder component and is represented by the formula (1) (i.e., a silane-coupling agent) and (c) a metal chelate compound which is a crosslinking agent. That is, since the antireflection film formed on the surface of the glass substrate contains the hollow silica sol (b), the K ions contained in the treating solution permeate through the antireflection film to substitute for the Na ions contained in the glass substrate in the subsequent treatment of chemical reinforcement based on the exchange of ions. Therefore, it is allowed to form the antireflection film prior to the chemically reinforcing treatment.

Namely, in the invention, since the chemically reinforcing treatment can be conducted after the antireflection film has been formed, it is allowed to form the antireflection film prior to shaping the glass substrate. Besides, as will be understood from the components that are contained, the antireflection film is formed by the sol-gel method. By forming the antireflection film prior to the shaping, therefore, it is allowed to fully utilize the advantages of the sol-gel method, such as low production cost and high productivity.

### MODES FOR CARRYING OUT THE INVENTION

In the production method of the present invention, a predetermined glass substrate is provided, an antireflection film is formed on the surface of the glass substrate, the glass substrate is shaped and, thereafter, the chemically reinforcing treatment is conducted to obtain a reinforced antireflection glass having a desired antireflection function.

<Glass substrate>

In the invention, the glass substrate may have any composition so far as it can be reinforced by the chemically reinforcing treatment. Desirably, however, the glass contains alkali metal ions or alkaline earth metal ions having a small ionic radius. For example, there can be desirably used soda-lime silicate glass, alkali aluminosilicate-containing glass or alkali borosilicate-containing glass. Among them, most desirably used are the ones containing Na ions.

That is, Na ions have a small ionic radius. Therefore, Glass which is contained Na ions can be easily substituted by the metal ions (e.g., K ions) having a relatively small ionic radius among the ions having ionic radii larger than that of the Na ions. Accordingly, despite the antireflection film has been formed, the glass substrate can be reinforced with its Na ions being more effectively substituted as will be described later. According to the invention, for instance, the glass containing not less than 5% by weight of Na ions is most desired.

There is no specific limitation on the thickness of the glass substrate. Generally, however, the thickness is in a range of not more than 1 mm from the standpoint of effectively conducting the chemically reinforcing treatment as will be described later.

<Forming the antireflection film>

The antireflection film is formed on the surface of the glass substrate by using a coating solution that contains a silicon compound, a hollow silica sol (b) and a metal chelate compound (c), applying the coating solution onto the surface of the glass substrate and heat-treating the coating solution.

Silicon compound:

The silicon compound in the coating solution is a binder component that is essential for forming a film that favorably and closely adheres to the glass substrate, and is a silicon compound or a partly hydrolyzed condensate thereof represented by the following formula (1),

Rₙ—Si(OR¹)₄₋ₙ (1)

Wherein,
R is an alkyl group or an alkenyl group,
R¹ is an alkyl group or an alkoxyalkyl group, and
n is an integer of 0 to 2.

Namely, upon being heat-treated, the silicon compound (or the partly hydrolyzed condensate thereof) represented by the formula (1) is hydrolyzed and condensed to form a hydrolyzed condensate of the silicon compound (a) that serves as a binder.

The silicon compound represented by the formula (1) has been known as a silane-coupling agent and has a function to undergo by itself the hydrolysis to form a siliceous film.

In the formula (1) representing the silicon compound, the alkyl group which is the group R may be methyl group, ethyl group, propyl group, butyl group, pentyl group, hexyl group, heptyl group or octyl group, and the alkenyl group which is the group R may be vinyl group or allyl group.

These groups R may have a substituent, respectively. As the substituent, there can be exemplified halogen atom such as chlorine and the like, and functional groups such as mercapto group, amino group, (meth)acryloyl group and oxyrane ring-containing group.

As the alkyl group which is the group R¹, there can be exemplified the same groups as the above groups R and as the alkoxyalkyl group, there can be exemplified the above alkyl groups but having, as a substituent, an alkoxy group such as methoxy group, ethoxy group, propoxy group or butoxy group.

The groups R and R¹ which are present in plural numbers may be the same or different from each other.

Described below are concrete examples of the silicon compound represented by the above general formula (1).

Silicon compounds with n=0.

Tetraalkoxysilanes such as:

tetramethoxysilane,

tetraethoxysilane,

tetrapropoxysilane, and

tetrabutoxysilane.

Silicon compounds with n=1.

Trialkoxysilanes such as:

methyltrimethoxy(ethoxy)silane,

methyltriphenoxysilane,

ethyltrimethoxy(ethoxy)silane,

propyltrimethoxy(ethoxy)silane,

butyltrimethoxy(ethoxy)silane,

hexyltrimethoxy(ethoxy)silane,

octyltrimethoxy(ethoxy)silane,

decyltrimethoxy(ethoxy)silane,

γ-(2-aminoethyl)aminopropyltrimethoxysilane,

γ-methacryloxypropyltrimethoxysilane,

γ-glycidoxypropyltrimethoxysilane,

γ-mercaptopropyltrimethoxysilane,

γ-chloropropyltrimethoxysilane,

vinyltrimethoxysilane, and

phenyltrimethoxysilane.

Silicon compounds with n =2.

Dialkoxysilanes such as:

dimethyldimethoxysilane,

dimethyldiethoxysilane,

diisopropyldimethoxysilane,

diisobutyldimethoxysilane,

cyclohexylmethyldimethoxysilane,

γ-chloropropylmethyldimethoxysilane,

γ-mercaptopropylmethyldimethoxysilane,

γ-glycidoxypropylmethyldimethoxysilane, and

γ-methacryloxypropylmethyldimethoxysilane.

(the above alkyl groups or alkenyl groups may be in a straight-chain form or branched form)

In the invention, among the compounds exemplified above, the silicon compounds with n=0 and n=1 are preferred from the standpoint of maintaining strength and, specifically, the tetraethoxysilane and γ-glycidoxypropyltrimethoxysilane are most desired. Namely, upon being hydrolyzed and condensed, the silicon compound forms a film. Here, the hydrolysis and condensation take place due to the alkoxy group that serves as a functional group. Therefore, the silicon compounds with n=0 and n=1 have alkoxy groups in numbers of as many as 4 or 3, forming a dense and highly strong film continuing like a three-dimensional mesh, which is best suited as an antireflection film formed on a reinforced glass that is obtained by the reinforcing treatment.

The silicon compound represented by the above formula (1) can also be used in the form of a hydrolyzed product.

Hollow silica sol (b):

The hollow silica sol (b) consists of fine hollow particles having a cavity therein and having a grain size (average grain size based on the volume as measured by the laser diffraction/light scattering method) of 5 to 150 nm. By using such a fine hollow silica sol, metal ions having a large ionic radius permeate through the antireflection film at the time of the chemically reinforcing treatment that will be described later so that ions can be exchanged with the metal ions having a small ionic radius contained in the glass substrate enabling the glass substrate to be effectively reinforced.

The above hollow silica sol (b) has been known as disclosed in, for example, JP-A-2001-233611. The present invention, however, selectively uses the hollow silica sol having a low refractive index or, concretely, having a refractive index in a range of 1.20 to 1.38 from the standpoint of attaining a high antireflective property. Namely, by using the hollow silica sol having a low refractive index, the refractive index of the antireflection film that is formed is greatly decreased to be not more than 1.44 so as to attain excellent antireflective property. It is, further, desired that the hollow silica sol has an outer shell of a thickness of about 1 to 5 nm from the standpoint of avoiding a decrease in the strength of the antireflection film that is formed.

To prepare a coating solution, the above hollow silica sol (b) is used in the form of a dispersion solution using, usually, a lower alcohol such as methanol, ethanol or propanol as a dispersion medium to prevent the aggregation thereof.

In the invention, the hollow silica sol (b) is used in such an amount that the weigh ratio (a/b) of the hydrolyzed condensate of the silicon compound (a) and the silica sol (b) is in a range of 50/50 to 90/10 and, preferably, 60/40 to 70/30. That is, if the hollow silica sol is used in too large amounts, the chemically reinforcing treatment can be effectively conducted but the antireflection film possesses a decreased mechanical strength, insufficient scratch resistance, impairing adhesiveness between the antireflection film and the glass substrate and permitting the film to be easily peeled off . If the amount of use is too small, on the other hand, it becomes difficult to exchange the metal ions through the antireflection film and to effectively conduct the chemically reinforcing treatment that will be described later.

Metal chelate compound (c):

The metal chelate compound which is the component (c) works as a crosslinking agent. Namely, upon using the metal chelate compound, the antireflection film is densely formed effectively suppressing a decrease in the strength and hardness of the film despite the above hollow silica sol is added.

As the metal chelate compound, there can be exemplified a compound of titanium, zirconium, aluminum, tin, niobium, tantalum or lead containing a bidentate ligand. The bidentate ligand is a chelating agent having a coordination number of 2, i.e., having 2 atoms that can be coordinated in a metal and, usually, forms a chelate compound by forming a 5- to 7-membered ring with O, N or S atoms.

As shown in Encyclopaedia Chimica, Vol. 6, concrete examples of the bidentate ligand include acetylacetonato, ethyl acetoacetato, diethyl malonato, dibenzoyl methanato, salicylato, glycolato, catecholato, salicylaldehydato, oxyacetophenonato, biphenolato, pyromeconato, oxynaphthoquinonato, oxyanthraquinonato, tropolonato, hinokitilato, glycinato, araninato, anthroninato, picolinato, aminophenolato, ethanolaminato, mercaptoethylaminato, 8-oxyquinolynato, salicylaldiminato, benzoinoxymato salicylaldoxymato, oxyazobenzenato, phenylazonaphtholato, β-nitroso-α-naphtholato, diazoaminobenzenato, biuretato, diphenylcarbazonato, diphenylthiocarbazonato, biguanidato and dimethylglyoxymato to which only, however, the bidentate ligand is not limited.

In the invention, a preferred metal chelate compound is represented by the following formula (2),

M(Li)ₖ(X)ₘ₋ₖ (2)

Wherein,
M is titanium, zirconium, aluminum, tin, niobium, tantalum or lead,
Li is a bidentate ligand,

X is a monovalent group and, preferably, a hydrolyzable group,
m is a valence of a metal M, and
k is a number of not smaller than 1 in a range of not
exceeding the valence of the metal M.

Among them, the metal M is, preferably, titanium, zirconium or aluminum, and the group X is, preferably, alkoxy group. Concretely, there can be exemplified the following titanium chelates, zirconium chelates and aluminum chelates.

Titanium chelates:
triethoxy.mono(acetylacetonato)titanium,
tri-n-propoxy.mono(acetylacetonato)titanium,
tri-i-propoxy.mono(acetylacetonato)titanium,
tri-n-butoxy.mono(acetylacetonato)titanium,
tri-sec-butoxy.mono(acetylacetonato)titanium,
tri-t-butoxy-mono(acetylacetonato)titanium,
diethoxy.bis(acetylacetonato)titanium,
di-n-propoxy.bis(acetylacetonato)titanium,
di-i-propoxy.bis(acetylacetonato)titanium,
di-n-butoxy.bis(acetylacetonato)titanium,
di-sec-butoxy.bis(acetylacetonato)titanium,
di-t-butoxy.bis(acetylacetonato)titanium,
monoethoxy.tris(acetylacetonato)titanium,
mono-n-propoxy.tris(acetylacetonato)titanium,
mono-i-propoxy.tris(acetylacetonato)titanium,
mono-n-butoxy.tris(acetylacetonato)titanium,
mono-sec-butoxy.tris(acetylacetonato)titanium,
mono-t-butoxy.tris(acetylacetonato)titanium,
tetrakis(acetylacetonato)titanium,
triethoxy.mono(ethylacetoacetato)titanium,
tri-n-propoxy.mono(ethylacetoacetato)titanium,
tri-i-propoxy.mono(ethylacetoacetato)titanium,
tri-n-butoxy.mono(ethylacetoacetato)titanium,
tri-sec-butoxy.mono(ethylacetoacetato)titanium,
tri-t-butoxy.mono(ethylacetoacetato)titanium,
diethoxy.bis(ethylacetoacetato)titanium,
di-n-propoxy.bis(ethylacetoacetato)titanium,
di-i-propoxy.bis(ethylacetoacetato)titanium,
di-n-butoxy.bis(ethylacetoacetato)titanium,
di-sec-butoxy.bis(ethylacetoacetato)titanium,
di-t-butoxy.bis(ethylacetoacetato)titanium,
monoethoxy.tris(ethylacetoacetato)titanium,
mono-n-propoxy.tris(ethylacetoacetato)titanium,
mono-i-propoxy.tris(ethylacetoacetato)titanium,
mono-n-butoxy.tris(ethylacetoacetato)titanium,
mono-sec-butoxy.tris(ethylacetoacetato)titanium,
mono-t-butoxy.tris(ethylacetoacetato)titanium,
tetrakis(ethylacetoacetato)titanium,
mono(acetylacetonato)tris(ethylacetoacetato) titanium,
bis(acethylacetonato)bis(ethylacetoacetato)titanium, and
tris(acetylacetonato)mono(ethylacetoacetato) titanium.
   Zirconium chelates:
triethoxy.mono(acetylacetonato)zirconium,
tri-n-propoxy.mono(acetylacetonato)zirconium,
tri-i-propoxy.mono(acetylacetonato)zirconium,
tri-n-butoxy.mono(acetylacetonato)zirconium,
tri-sec-butoxy.mono(acetylacetonato)zirconium,
tri-t-butoxy.mono(acetylacetonato)zirconium,
diethoxy.bis(acetylacetonato)zirconium,
di-n-propoxy.bis(acetylacetonato)zirconium
di-i-propoxy.bis(acetylacetonato)zirconium
di-n-butoxy.bis(acetylacetonato)zirconium
di-sec-butoxy.bis(acetylacetonato)zirconium,
di-t-butoxy.bis(acetylacetonato)zirconium,
monoethoxy.tris(acetylacetonato)zirconium,
mono-n-propoxy.tris(acetylacetonato)zirconium,
mono-i-propoxy.tris(acetylacetonato)zirconium,
mono-n-butoxy.tris(acetylacetonato)zirconium,
mono-sec-butoxy.tris(acetylacetonato)zirconium,
mono-t-butoxy.tris(acetylacetonato)zirconium,
tetrakis(acetylacetonato)zirconium,
triethoxy.mono(ethylacetoacetato)zirconium,
tri-n-propoxy.mono(ethylacetoacetato)zirconium,
tri-i-propoxy.mono(ethylacetoacetato)zirconium,
tri-n-butoxy.mono(ethylacetoacetato)zirconium,
tri-sec-butoxy.mono(ethylacetoacetato)zirconium,
tri-t-butoxy.mono(ethylacetoacetato)zirconium,
diethoxy.bis(ethylacetoacetato)zirconium,
di-n-propoxy.bis(ethylacetoacetato)zirconium,
di-i-propoxy.bis(ethylacetoacetato)zirconium,
di-n-butoxy.bis(ethylacetoacetato)zirconium,
di-sec-butoxy.bis(ethylacetoacetato)zirconium,
di-t-butoxy.bis(ethylacetoacetato)zirconium,
monoethoxy.tris(ethylacetoacetato)zirconium,
mono-n-propoxy.tris(acetylacetonato)zirconium,
mono-i-propoxy.tris(ethylacetoacetato)zirconium,
mono-n-butoxy.tris(ethylacetoacetato)zirconium,
mono-sec-butoxy.tris(ethylacetoacetato)zirconium,
mono-t-butoxy.tris(ethylacetoacetato)zirconium,
tetrakis(ethylacetoacetato)zirconium,
mono(acetylacetonato)tris(ethylacetoacetato) zirconium,
bis(acetylacetonato)bis(ethylacetoacetato) zirconium, and
tris(acetylacetonato)mono(ethylacetoacetato) zirconium.
   Aluminum chelates:
diethoxy.mono(acetylacetonato)aluminum,
monoethoxy.bis(acetylacetonato)aluminum,
di-i-propoxy.mono(acetylacetonato)aluminum,
mono-i-propoxy.bis(acetylacetonato)aluminum,
mono-i-propoxy.bis(ethylacetoacetato)aluminum,
monoethoxy.bis(ethylacetoacetato)aluminum,
diethoxy.mono(ethylacetoacetato)aluminum, and
di-i-propoxy.mono(ethylacetoacetato)aluminum.

In the invention, a particularly preferred metal chelate compound is an aluminum chelate.

The above metal chelate compound is used in an amount of not more than 20 parts by weight, preferably, 0.01 to 20 parts by weight and, specifically, 1 to 5 parts by weight per a total of 100 parts by weight of the hydrolyzed condensate of the silicon compound (a) and the silica sol (b). If used in too large amounts, the refractive index of the antireflection film becomes so high that the antireflective property decreases and, besides, ions are exchanged little through the film, and the glass substrate is not chemically reinforced effectively. If used in too small amounts, on the other hand, the strength and hardness of the antireflection film decrease, and the treatment for chemically reinforcing the glass substrate loses effectiveness.

Other components of the coating solution:

In the invention, the silicon compound represented by the above formula (1), hollow silica sol (b) and metal chelate compound (c) are dissolved or dispersed in an organic solvent, and are used in the form of a coating solution. Any and a variety of organic solvents can be used without limitation if they do not cause precipitation and enables the components to be effectively dissolved or dispersed. Usually, however, there are used alcohol solvents such as methanol, ethanol, isopropanol, ethyl cellosolve and ethylene glycol; ester solvents such as ethyl acetate and butyl acetate; ketone solvents such as acetone and methyl ethyl ketone; aromatic solvents such as toluene and xylene; and amide solvents such as dimethylformamide and dimethylacetamide. Alcohol solvents, however, are particularly preferred.

The organic solvent is used in such an amount that the coating solution is so viscous as will not drip and is suited for forming a coating. Usually, the organic solvent may be used in such an amount that the concentration of the whole solid components is 0.1 to 20% by weight of the whole weight. Here, the hollow silica sol (b) is used in a form of being dispersed in the dispersion medium such as alcohol solvent and, therefore, the amount of the organic solvent is the amount inclusive of the amount of the dispersion medium. Therefore, in case the dispersion medium of the hollow silica sol (b) is used in large amounts, a coating solution may be prepared without using a separate organic solvent but adding other components directly to the dispersion solution of the hollow silica sol (b).

The above coating solution may be, further, blended with other additives in small amounts in addition to the above silicon compound of the formula (1), hollow silica gel (b) and metal chelate compound (c), in a range in which they do not impair the object of forming the antireflection film that can be chemically reinforced and exhibits excellent properties such as strength. For example, there can be added an alkoxide of a polyvalent metal or, concretely, an alkoxide of titanium, aluminum, zirconium or tin in small amounts. The alkoxide of the above polyvalent metal, too, works as a crosslinking agent like the metal chelate compound, and makes it possible to form a dense film having increased strength and hardness.

In order to accelerate the hydrolysis and condensation of the silicon compound of the formula (1) , further, an aqueous solution of acid such as an aqueous solution of hydrochloric acid may be added in a suitable amount into the coating solution.

Forming the film:

To form the film, the above coating solution is applied onto the surface of the glass substrate, and is dried and heat-treated (fired). The heat treatment is conducted at a temperature at which the glass substrate is not deformed, generally, at about 300 to 500° C. for about 10 minutes to 4 hours. Due to the heat treatment, the silicon oxide represented by the above formula (1) is hydrolyzed and is condensed (i.e., gelled) with the metal chelate compound (c) and with a metal alkoxide that is suitably added to form an antireflection film in a form of incorporating the hollow silica sol (b) therein, which is dense but permits ions to be exchanged therethrough. That is, the antireflection film contains the hollow silica sol at the above-mentioned weight ratio (a/b) relative to the hydrolyzed condensate of the binder component (silicon compound represented by the formula (1)) (a) and permits ions to be exchanged therethrough.

The antireflection film formed as described above has a thickness in a range of 50 to 150 nm and, specifically, 90 to 120 nm. If the thickness of the film is small, the antireflective function cannot be fully exhibited and, besides, the film thickness disperses resulting in the dispersion in the properties of the antireflection film. If the film thickness is too large, on the other hand, it becomes difficult to exchange the ions in the glass substrate through the film as a matter of course, and the chemically reinforcing treatment cannot be effectively conducted.

The above antireflection film is formed on a suitable position of the glass substrate depending upon the use; i.e., formed on one surface of the glass substrate or formed on the whole surfaces on the front side and back side of the glass substrate.

### <Shaping>

In the invention, the shaping is conducted depending upon the use, i.e., machining is conducted, such as cutting, machining of end surfaces or perforation after the antireflection film has been formed on the surface of the glass substrate as described above but before conducting the chemically reinforcing treatment. This is because the machining cannot be conducted after the glass substrate has been reinforced by the chemically reinforcing treatment.

Through the shaping, the glass substrate having the antireflection film is imparted with the shape of a final product.

<Chemically reinforcing treatment>

As described already, the chemically reinforcing treatment is finally conducted to highly reinforce the glass substrate by substituting metal ions having a large ionic radius for the metal ions having a small ionic radius contained in the glass substrate. Thus, there is obtained a reinforced glass product having the antireflection film formed on the surface thereof.

The chemically reinforcing treatment can be conducted in a customary manner. Concretely, the glass substrate having the antireflection film is brought into contact with a melt of a metal salt containing large metal ions by, for example, dipping to substitute large metal ions for small metal ions in the glass substrate. For example, by bringing the glass substrate containing Na ions into contact with a melt of a potassium salt such as potassium nitrate, Na ions having a small ionic radius are substituted by K ions having a large ionic radius, and the glass substrate turns into a reinforced glass having a large strength.

Namely, in the invention, the antireflection film contains the hollow silica sol (b) at a predetermined ratio. When the glass substrate is brought into contact with the melt of a metal salt containing large metal ions, therefore, the large metal ions permeate through the antireflection film enabling the chemically reinforcing treatment to be conducted by the exchange of ions. For example, if the antireflection film is blended with the hollow silica sol as demonstrated in Comparative Example 1 appearing later, large metal ions permeate little through the film. Therefore, the degree of reinforcement is very low.

In the chemically reinforcing treatment based on the exchange of ions, the fluidity of the melt increases with an increase in the temperature of the melt, and the treatment is conducted in a short period of time. In this treatment, therefore, the temperature of the melt is set to a temperature at which the shaped glass substrate is not deformed, e.g., to a temperature of about 400 to 460° C., and the treating time is, usually, about 3 to 15 hours.

As described above, the reinforced final glass product is obtained having the antireflection film on the surface of the reinforced glass.

The reinforced glass product is favorably used for the products having a thin glass substrate, such as whole-surface protection panels of electrostatic capacity-type touch panels, digital cameras and displays of a variety of mobile devices such as cell phones.

In the invention, the antireflection film can be formed on the surface of the glass substrate that is turned into the reinforced glass in the step preceding the step of shaping. It is, therefore, made possible to produce the final reinforced glass product having the antireflection film on the surface of the reinforced glass maintaining a very high productivity and at a low cost.

### EXAMPLES

The invention will be described in further detail by way of Examples described below to which only, however, the invention is in no way limited.

In Examples, measurements were taken by the methods described below.

(1) Ray of light reflection factor:

By using a tester, V-550, manufactured by Nihon Bunko Co. , the reflection factor was measured using a ray of light of a wavelength of 550 nm.

### (2) Strength:

By using a point-press testing machine manufactured by IMDA Co., a sample of a size of 50×50 was placed on a stainless steel jig having a hole of 45φ, and the center thereof was pressed with a steel ball of 10φ to measure a maximum breaking strength and to evaluate the strength.

(3) Surface hardness:

By using a steel wool #0000, the surface of the sample was rubbed 5 round trips (one round trip/sec., distance of 100 mm/one round trip) while applying a load of 500 g/cm² thereto to observe the occurrence of scratches in the surface of the antireflection film.

In the following Examples, there were used the following glass substrates, hollow silica sol, and colloidal silica for comparison.

Glass substrates:

Soda glass (200 mm×200 mm×0.7 mm)

White sheet glass (200 mm×200 mm×0.7 mm)

Hollow silica sol (manufactured by Nikki Shokubai Kasei Co.):

Average particle size: 40 nm

Solid component: 20% by weight

Dispersion solvent: isopropanol (IPA)

Colloidal silica:

Particle size: 40 to 50 nm

Solid content: 30% by weight

Dispersion solvent: isopropanol (IPA)

### Example 1

There were used the hollow silica sol dispersed in the isopropanol (IPA) described above, a hydrolyzed product of tetraethoxysilane (TEOS) (containing 0.05N hydrochloric acid), aluminum acetylacetonate as the metal chelate compound, as well as isopropanol (IPA) as the organic solvent, which were then mixed together to prepare a coating solution of the following composition.

Coating solution composition:

TEOS hydrolyzed product (containing 0.05 N hydrochloric acid): 5.03 parts by weight

(TEOS: 2.72 parts by weight, hydrochloric acid: 2.31 parts by weight)

Hollow silica sol (containing IPA): 6.25 parts by weight (silica sol: 1.25 parts by weight, IPA: 5.00 parts by weight)

IPA: 88.70 parts by weight

Aluminum acetylacetonate: 0.04 parts by weight (TEOS hydrolyzed product/hollow silica sol= 69/31)

The above coating solution was applied onto the float glass by dip coating, baked at 500° C. for 2 hours to form an antireflection film to thereby obtain a sample glass plate.

The above sample glass plates were prepared in a number of 5, and were chemically reinforced by being dipped in the molten potassium nitride heated at 450° C. for 8 hours.

The above sample glass substrates and the chemically treated sample substrates were evaluated for their ray of light reflection factors, strengths and surface hardness according to the above-mentioned methods to obtain the results as shown in Table 1 which also shows the compositions of the coating solutions (antireflection films).

The ray of light reflection factor and the strength are average values of the five samples. As for the strength, Table 1 also shows a value of the glass substrate (starting glass) of before the antireflection film is formed.

### Example 2

A sample glass plate forming an antireflection film thereon was prepared in the same manner as in Example 1 but changing the composition of the coating solution as shown in Table 1, and was chemically reinforced in the same manner and evaluated in the same manner as in Example 1 to obtain results as shown in Table 1.

### Example 3

A sample glass plate forming an antireflection film thereon was prepared in the same manner as in Example 1 but changing the glass substrate into a white sheet glass, and was chemically reinforced in the same manner and evaluated in the same manner as in Example 1 to obtain results as shown in Table 1.

### Example 4

A sample glass plate forming an antireflection film thereon was prepared in the same manner as in Example 1 but using a γ-glycidoxypropyltrimethoxysilane (γ-GPS) instead of using the tetraethoxysilane and using a coating solution of a composition shown in Table 1, and was chemically reinforced in the same manner and evaluated in the same manner as in Example 1 to obtain results as shown in Table 1.

### Example 5

A sample glass plate forming an antireflection film thereon was prepared in the same manner as in Example 1 but changing the composition of the coating solution as shown in Table 1, and was chemically reinforced in the same manner and evaluated in the same manner as in Example 1 to obtain results as shown in Table 1.

### Comparative Example 1

A sample glass plate forming an antireflection film thereon was prepared in the same manner as in Example 1 but using no hollow silica sol and using a coating solution of a composition shown in Table 2, and was chemically reinforced in the same manner and evaluated in the same manner as in Example 1 to obtain results as shown in Table 2.

### Comparative Example 2

A sample glass plate forming an antireflection film thereon was prepared in the same manner as in Example 1 using the hollow silica sol but using a coating solution of a composition that was changed as shown in Table 2, and was chemically reinforced in the same manner and evaluated in the same manner as in Example 1 to obtain results as shown in Table 2.

### Comparative Example 3

A sample glass plate forming an antireflection film thereon was prepared in the same manner as in Example 1 but using colloidal silica instead of the hollow silica sol and using a coating solution of a composition that was changed as shown in Table 2, and was chemically reinforced in the same manner and evaluated in the same manner as in Example 1 to obtain results as shown in Table 2.

### Comparative Example 4

A sample glass plate forming an antireflection film thereon was prepared in the same manner as in Comparative Example 3 but using a coating solution of a composition that was changed as shown in Table 2, and was chemically reinforced in the same manner and evaluated in the same manner as in Example 1 to obtain results as shown in Table 2.

TABLE 1

| | Ex. 1 | | Ex. 2 | | Ex. 3 | | Ex. 4 | | γ-GPS/ | |
|---|---|---|---|---|---|---|---|---|---|---|
| | TEOS/silica | | TEOS/silica | | TEOS/silica | | γ-GPS/silica | | silica | |
| | sol = 69/31 | | sol = 83/17 | | sol = 69/31 | | sol = 55/45 | | sol = 74/26 | |
| Glass substrate | | | | | | | | | | |
| Soda glass | ◯ | | ◯ | | | | ◯ | | ◯ | |
| White sheet glass | | | | | ◯ | | | | | |
| Antireflection film blend | | | | | | | | | | |
| TEOS(#1) hydrolyzed product | 5.03 | | 8.50 | | 5.03 | | | | | |
| TEOS | | 2.72 | | 4.59 | | 2.72 | | | | |
| 0.05N hydrochloric acid | | 2.31 | | 3.91 | | 2.31 | | | | |
| γ-GPS(#2) hydrolyzed product | | | | | | | 2.68 | | 4.60 | |
| γ-GPS | | | | | | | | 1.52 | | 2.61 |
| 0.05N hydrochloric acid | | | | | | | | 1.16 | | 1.99 |
| Hollow silica sol | 6.25 | | 4.60 | | 6.25 | | 6.25 | | 4.60 | |
| sol solid component | | 1.25 | | 0.92 | | 1.25 | | 1.25 | | 0.92 |
| dispersion solvent: IPA | | 5.00 | | 3.68 | | 5.00 | | 5.00 | | 3.68 |
| Colloidal silica, | | | | | | | | | | |
| particle size 40-50 nm | | | | | | | | | | |
| sol solid component | | | | | | | | | | |
| dispersion solvent: IPA | | | | | | | | | | |
| IPA | | | | | | | | | | |
| solvent | | 88.70 | | 87.00 | | 88.70 | | 91.03 | | 90.74 |
| Aluminum acetylacetonate | | 0.04 | | 0.06 | | 0.04 | | 0.04 | | 0.06 |
| Total | | 100.02 | | 100.16 | | 100.02 | | 100.00 | | 100.00 |

| | | | | | |
|---|---|---|---|---|---|
| Baking of antireflection film | 500° C. 2 hrs | 500° C. 2 hrs | 500° C. 2 hrs | 500° C 2 hrs | 500° C. 2 hrs |
| Thickness of antireflection | 106 | 103 | 106 | 101 | 98 |
| film (nm) | | | | | |
| Chemical reinforcing treatment | yes | yes | yes | yes | yes |
| Properties | | | | | |
| Reflection factor | | | | | |
| Before chemically treated | 0.5% | 1.3% | 0.5% | 1.8% | 3.0% |
| After chemically treated | 0.5% | 1.3% | 0.5% | 1.8% | 3.0% |
| Strength | | | | | |
| Before applying AR coating | 198N | 187N | 282N | 206N | 221N |
| (starting glass) | | | | | |
| After chemically treated | 380N | 365N | 423N | 401N | 372N |
| Surface hardness | slightly | no scratch | slightly | scratched | slightly |
| | scratched | | scratched | | scratched |

(#1)tetraethoxysilane
(#2)γ-glycidoxypropyltrimethoxysilane

TABLE 2

| | | | | | Comp. Ex. 3 | | Comp. Ex. 4 | |
|---|---|---|---|---|---|---|---|---|
| | | | Comp. Ex. 2 | | No refraction- | | No refraction- | |
| | Comp. Ex. 1 | | TEOS/silica | | lowering | | lowering | |
| | No sol | | sol = 48/52 | | treatment = 68/32 | | treatment = 84/16 | |
| Glass substrate | | | | | | | | |
| Soda glass | ◯ | | ◯ | | ◯ | | ◯ | |
| White sheet glass | | | | | | | | |
| Antireflection film blend | | | | | | | | |
| TEOS(#1) hydrolyzed product | 12.00 | | 2.40 | | 5.00 | | 8.50 | |
| TEOS | | 6.48 | | 1.30 | | 2.70 | | 4.59 |
| 0.05N hydrochloric acid | | 5.52 | | 1.10 | | 2.30 | | 3.91 |
| γ-GPS(#2) hydrolyzed product | | | | | | | | |
| γ-GPS | | | | | | | | |
| 0.05N hydrochloric acid | | | | | | | | |
| Hollow silica sol | | | 7.00 | | | | | |
| sol solid component | | | | 1.40 | | | | |
| dispersion solvent: IPA | | | | 5.60 | | | | |
| Colloidal silica, | | | | | 4.20 | | 3.00 | |
| particle size 40-50 nm | | | | | | | | |
| sol solid component | | | | | | 1.26 | | 0.90 |
| dispersion solvent: IPA | | | | | | 2.94 | | 2.10 |
| IPA | | | | | | | | |
| solvent | | 87.90 | | 90.60 | | 90.80 | | 88.50 |
| Aluminum acetylacetonate | | 0.10 | | 0.02 | | 0.04 | | 0.06 |
| Total | | 100.00 | | 100.02 | | 100.04 | | 100.06 |

| | | | | |
|---|---|---|---|---|
| Baking of antireflection film | 500° C. 2 hrs | 500° C. 2 hrs | 500° C 2 hrs | 500° C 2 hrs |
| Thickness of antireflection | 94 | 106 | 94 | 94 |
| film (nm) | | | | |
| Chemical reinforcing treatment | yes | yes | yes | yes |
| Properties | | | | |
| Reflection factor | | | | |
| Before chemically treated | 6.0% | 0.5% | 5.7% | 6.0% |
| After chemically treated | 6.0% | 0.5% | 5.7% | 6.0% |
| Strength | | | | |
| Before applying AR coating | 215N | 201N | 209N | 226N |
| (starting glass) | | | | |
| After chemically treated | 238N | 397N | 233N | 255N |
| Surface hardness | no scratch | countless | no scratch | no scratch |
| | | scratches | | |
| | | (partly peeled) | | |

(#1)tetraethoxysilane
(#2)γ-glycidoxypropyltrimethoxysilane

1. A method of producing a reinforced antireflection glass by forming an antireflection film on the surface of a glass substrate and, thereafter, subjecting the glass substrate on which the antireflection film has been formed to a chemically reinforcing treatment based on the ion-exchange method,
wherein said antireflection film contains:
(a) a hydrolyzed condensate of a silicon compound represented by the following formula (1),
Rₙ—Si (OR¹)₄₋ₙ 1)
Wherein,
R is an alkyl group or an alkenyl group,
R¹ is an alkyl group or an alkoxyalkyl group, and
n is an integer of 0 to 2,
(b) a silica sol of a grain size of 5 to 150 nm and having a cavity therein, and
(c) a metal chelate compound,
the weight ratio (a/b) of said hydrolyzed condensate of the silicon compound (a) and the silica sol (b) being in a range of 50/50 to 90/10, and said metal chelate compound (c) being contained in an amount of not more than 20 parts by weight per a total of 100 parts by weight of said hydrolyzed condensate of the silicon compound (a) and the silica sol (b).

2. The method of producing a reinforced antireflection glass according to claim 1, wherein said antireflection film contains said metal chelate compound (c) in an amount of 0.01 to 20 parts by weight per a total of 100 parts by weight of said hydrolyzed condensate of the silicon compound (a) and the silica sol (b).

3. The method of production according to claim 1, wherein said antireflection film has a thickness in a range of 50 to 150 nm.

4. The method of production according to claim 1, wherein said silicon compound is a compound of the general formula (1) in which n is 0 or 1.

5. The method of production according to claim 3, wherein said silicon compound is a tetraethoxysilane or a γ-glycidoxypropyltrimethoxysilane.

6. The method of production according to claim 1, wherein after said antireflection film has been formed, the glass substrate is shaped prior to being subjected to said chemically reinforcing treatment.
